(19) United States
(12) Patent Application Publication
(10) Pub. No.: US 2008/0273143 A1
(43) Pub. Date: Nov. 6, 2008

(54) PASSIVE OPTICAL DEVICE AND LIGHT SOURCE MODULE

(75) Inventors: Po-Hung Yao, Kaohsiung County (TW); Yem-Yeu Chang, Chiayi County (TW); Yi-Hsin Lin, Taoyuan County (TW); Wen-Hsun Yang, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 11/852,335

(22) Filed: Sep. 10, 2007

(30) Foreign Application Priority Data
May 4, 2007 (TW) 96115829

(51) Int. Cl. G02F 1/1334; G02F 1/13357

(52) U.S. Cl. 349/64; 349/87

(57) ABSTRACT

A passive optical device includes a first substrate, a second substrate, a stabilized liquid crystal (LC) layer and a surface micro-structure layer. The stabilized LC layer is disposed between the first substrate and the second substrate and has a polarization beam-splitting function via an aligning direction of liquid crystal molecules. The surface micro-structure layer is disposed on an exterior surface of at least one of the first substrate and the second substrate and used to produce a light-collecting effect.

### CROSS-REFERENCE TO RELATED APPLICATION

This application claims the priority benefit of Taiwan application serial no. 96115829, filed May 4, 2007. All disclosure of the Taiwan application is incorporated herein by reference.

### BACKGROUND OF THE INVENTION

1. Field of the Invention

The present invention is related to an optical device with high efficiency suitable to be applied in a light source module.

2. Description of Related Art

The liquid crystal display (LCD) apparatus has been a common commercial product with extensive application. The general LCD apparatus, as shown in FIG. 1, includes a backlight module 100 to produce a planar light and an LCD panel to display images through the planar light. The LCD panel normally includes a lower substrate 104, an upper substrate 112 and a liquid crystal layer 108 disposed therebetween. The lower substrate 104 includes a structure layer 106 having a transparent electrode and a driving component and a polarizer 102. The upper substrate 112 includes a structure layer 110 having a transparent electrode and a polarizer 114. An aligning direction of liquid crystal molecules is controlled by the electrode on the substrate so as to determine the gray scale value of pixels. In addition, the three colors filters can be combined to obtain a desired color. Further details thereof are omitted herein.

For an LCD apparatus, the brightness of its displayed images is provided by a backlight module. However, since there are many components in the LCD panel along with the light absorption effect of the color filters, the light absorption effect of the polarizers and the low aspect ratio of the TFT, normal LCD apparatuses may only use 5%-10% of the light emitted from the backlight module. Consequently, the light utilization is too low such that a great deal of energy is wasted. Although some designs intended to increase light utilization have been proposed in the prior art, such as disclosed in U.S. Pat. No. 5,828,488 about a multi-layer structure constituted by stacking layers of polymer material with different birefringence ratios, so as to cyclically increase the light utilization. Moreover, U.S. Pat. No. 6,025,897 discloses that a polarizer material and a prism optical material can be integrated on one single component so as to improve the light utilization.

However, since optical films required by the back light are in a great demand, developing new optical films with functions integrated therein has a great value in application. The manufacturer still enthusiastically seeks to develop other designs in the hope of improving light utilization.

### SUMMARY OF THE INVENTION

The present invention is directed to a passive optical device which integrates the components and improves the functions so as to effectively reduce the fabricating cost and save energy.

The invention is directed to a passive optical device including a first substrate, a second substrate, a polymer stabilized liquid crystal material layer and a surface micro-structure layer. The polymer stabilized liquid crystal material layer is disposed between the first substrate and the second substrate and is rendered with a polarizing function and a beam-splitting function by an aligning direction of a plurality of liquid crystal molecules. The surface micro-structure layer is disposed on an exterior surface of at least one of the first substrate and the second substrate so as to redirect incident light.

The invention is further directed to a light source module including a light source unit so as to provide a planar light. A diffusion plate is disposed above the light source unit for receiving the lamp-emitted light so as to diffuse it uniformly. The passive optical device is disposed above the diffusion plate.

In order to the make the aforementioned and other objects, features of the present invention more comprehensible, several embodiments accompanied with figures are described in detail below.

### BRIEF DESCRIPTION OF THE DRAWINGS

FIG. 1 illustrates a schematic cross-sectional structure diagram of a conventional liquid crystal display (LCD) apparatus.

FIG. 2 illustrates a schematic cross-sectional view of a passive optical device according to one embodiment of the present invention.

FIG. 3 illustrates a schematic structure diagram of two substrates according to one embodiment of the invention.

FIG. 4 illustrates a schematic cross-sectional view of a light source module according to one embodiment of the invention.

FIGS. 5-8 illustrate schematic structure diagrams of surface micro-structures according to embodiments of the invention.

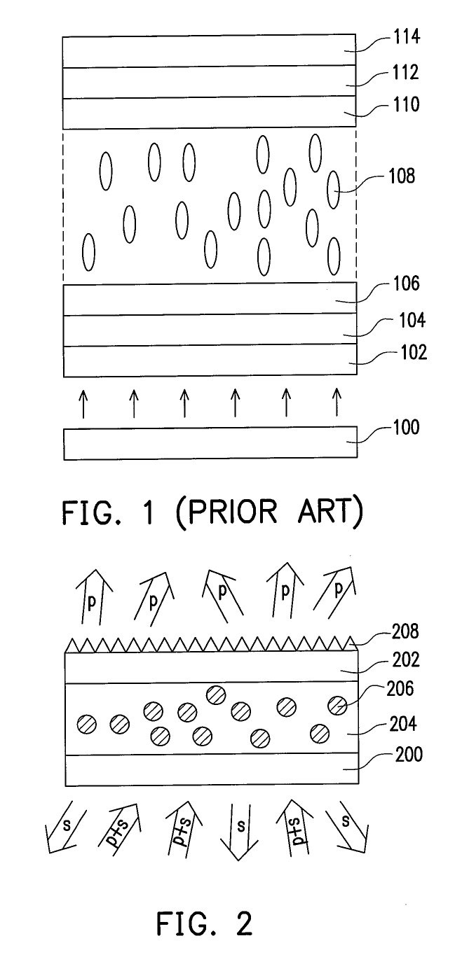

### DESCRIPTION OF EMBODIMENTS

The present invention is directed to a use of a polymer stabilized liquid crystal material layer, such as a polymer stabilized liquid crystal material, combined with a micro-structure so as to form an integrated optical film with high efficiency having the functions of converting polarization and increasing central brightness. If the invention is applied to an LCD apparatus, the light transmission efficiency and the central brilliance thereof can be substantially improved and the number of films required for the LCD apparatus is reduced such that the overall structure is simplified and the fabrication cost is lowered.

The polymer stabilized liquid crystal material is featured by mixing liquid crystal molecules with a polymer liquid adhesive. Through the bonding of the polymer material, the liquid crystal molecules can uniformly distribute in the polymer material and be coated on the substrate(s). When an ultraviolet light is used to cure the polymer material, the liquefied liquid crystal molecules would form into liquid crystal drops distributed stably and uniformly in the cured polymer material because of a phase separation. Further, the polymer material includes polyethylene terephthalate (PET), polystyrene (PS), cyclic olefin copolymer (COC), polymethyl methacrylate (PMMA) or polycarbonate (PC).

During the foregoing fabricating process, the liquid crystal droplets in uniform distribution can be formed and liquid crystal molecules in the liquid crystal droplets are approximately aligned in the same direction. However, an aligning direction of each of the liquid crystal molecules in the liquid crystal droplets is distributed randomly in an environment without electric fields. Therefore, the liquid crystal molecules basically do not have a polarizing function.

In order to render the stabilized liquid crystal material thus fabricated with a polarizing function, during the process of curing the polymer, an exterior electric field (or an exterior aligning force) is pre-applied so that the liquid crystal molecules in the liquid crystal drops would have already been aligned approximately in an intended direction during the curing process. Thus, after the polymer is actually cured and without any electric field, the plurality of liquid crystal molecules in each of the liquid crystal droplets are substantially aligned in a predetermined direction so that the liquid crystal molecules can have a polarizing function simultaneously.

FIG. 2 illustrates a schematic cross-sectional view of a passive optical device according to one embodiment of the invention. Referring to FIG. 2, the passive optical device of the invention includes a first substrate 200, a second substrate 202, a polymer stabilized liquid crystal material layer 204 and a surface micro-structure layer 208. The two substrates 200 and 202 may be glass substrates or polymer transparent materials, for example.

The polymer stabilized liquid crystal material layer 204 is disposed between the first substrate 200 and the second substrate 202 and is rendered with a polarizing function and a beam-splitting function by an aligning direction of the plurality of liquid crystal molecules in the plurality of liquid crystal droplets 206. As mentioned above, during the process of curing the polymer stabilized liquid crystal material layer 204, for example, an exterior electric field can be simultaneously applied to align the liquid crystal molecules along the direction of the exterior electric field. Generally, an exterior electric field may be predetermined as a horizontal direction so as to obtain an intended aligning direction. With their characteristics, the liquid crystal molecules would reflect a light with a polarization state such as S and allow another light with a polarization state such as P to be transmitted. Alternatively, taking incident lights having an S polarization state and a P polarization state for an example, optical-components of the P polarization state light would transmit and optical-components of the S polarization state light would be reflected so that the effects of polarization and beam-splitting can be achieved. The S polarization state and the P polarization state are perpendicular to each other. Therefore, the polymer stabilized liquid crystal material layer 204 itself has a polarizing function and a beam-splitting function.

Furthermore, electrode structures can also be disposed on the substrates 200 and 202 and controlled by a voltage control unit so that electric fields are generated to further control how the aligning direction of the liquid crystal molecules 206 is rotated.

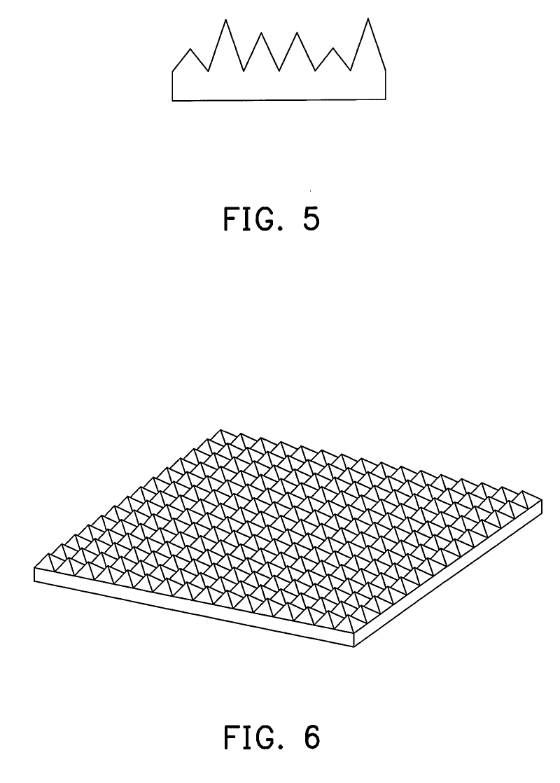

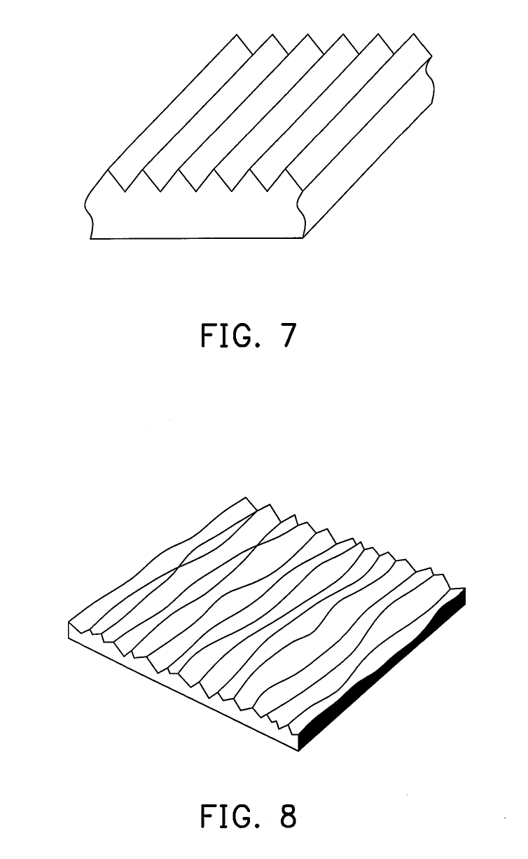

Moreover, the surface micro-structure 208 is disposed, for example, on an exterior surface of at least one of the substrate 200 and the substrate 202 so as to collect light. The surface micro-structure includes a regular linear extending structure, an irregular linear extending structure, a circular micro-lens array or a conical micro-lens array. The surface micro-structure layer 208 of FIG. 2 adopts a regular linear extending structure as an embodiment. In addition, FIGS. 5 through 8 illustrate schematic structure diagrams of some surface micro-structure layers. For example, FIG. 5 illustrates an irregular linear extending structure. FIG. 6 illustrates a pyramid array structure. For example, FIG. 7 illustrates a regular linear extending structure. FIG. 8 illustrates a curving structure, which can be regular or irregular.

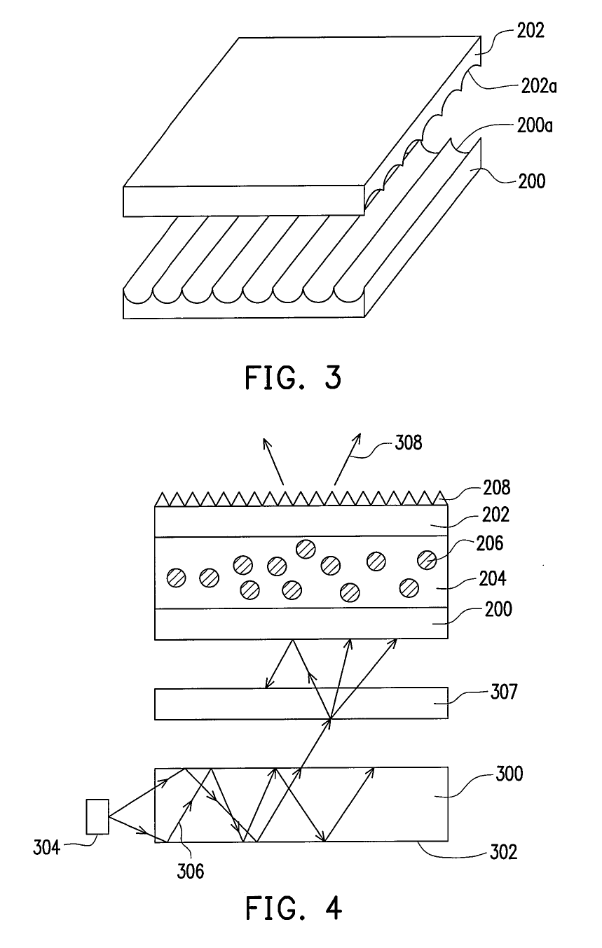

With another method, the liquid crystal molecules can be further orderly aligned in a predetermined direction so that the polarizing selectivity is further improved. FIG. 3 illustrates a schematic structure diagram of two substrates according to one embodiment of the invention. Referring to FIG. 3, in order to render the liquid crystal molecules more regularly aligned according to the intended direction when the polymer is cured, two aligning layers 200a and 202a can be added to interior surfaces of the two substrates 200 and 202 respectively. With the functioning of the aligning layers, liquid crystal molecules close to the aligning layers are more orderly aligned along aligning directions of the aligning layers so as to improve the polarizing selectivity. In this configuration, the exterior electric field (the exterior aligning force) can be applied or does not have to be applied depending on actual requirements. Since the aligning directions of the two aligning layers 200a and 202a may be perpendicular to each other, a transmitting selectivity for light from specific polarizing directions can be further improved so as to elevate a polarization purity of transparent components. However, the aligning directions of the two aligning layers 200a and 202a may also parallel each other depending on actual requirements.

Next, the optical device of the invention may be applied in a backlight module. FIG. 4 illustrates a schematic cross-sectional view of a light source module according to one embodiment of the invention. The light source module may be a backlight module as an example to facilitate illustration. Referring to FIG. 4, a light source unit is used to provide a planar light. The light source unit may be designed as constituted by a light source 304 and a light guide component 300. The light source 304 may be a linear light source or a light emitting diode (LED) to emit an initial light source. Since the initial light source is not a planar light, an initial light source 306 can be received by the light guide component 300 to guide and convert the initial light source into a planar light. The light guide component 300 may be a light guide plate converting the point light source into a planar mode of light. A reflective index of the light guide component 300 is larger than that of the air, and thus a phenomenon of total internal reflection on an interface would arise. Alternatively, a portion of light is still reflected back to an interior of the light guide component 300 from the interface because of an optical effect. In order to more effectively use the light source, a reflection plate 302 may be further disposed on a surface of the light guide component 300 so as to recycle some light source to be used continuously. Nevertheless, the light source unit mainly provides a planar light to some extent. The design of the light source unit does not limit the cited embodiments herein.

Since an intensity of the light emitted from the light source unit may not be uniform, a diffusion plate 307 can be used to render the light intensity uniformly distributed. Thereafter, light passing through the diffusion plate 307 enters the optical device as illustrated in FIG. 2. With the same mechanism, a light 308 having a polarized state would transmit the optical device and a light having another polarizing state would be reflected back to the diffusion plate 307. For the functioning of optical characteristics, the reflected light of a polarizing state is changed to generate a light having a partially transmittable polarizing state so that the light can be repetitively recycled for use and thereby ensuring the purity of a polarizing state of an outputted light 308.

The polymer stabilized liquid crystal material layer 204 is used in combination with the surface micro-structure layer 208 in the present invention to effectively improve utilization of the light from the light source 304 and simultaneously polarize the light and improve transmittance of the light passing through a lower polarizer. Further, preferably, the number of polarizers can be reduced.

Although the present invention has been disclosed above by the preferred embodiments, they are not intended to limit the present invention. Anybody skilled in the art can make some modifications and alterations without departing from the spirit and scope of the present invention. Therefore, the protecting range of the present invention falls in the appended claims.

What is claimed is:

1. A passive optical device, comprising:
a first substrate;
a second substrate;
a polymer stabilized liquid crystal material layer, disposed between the first substrate and the second substrate and rendered with a polarizing function and a beam-splitting function by an aligning direction of a plurality of liquid crystal molecules; and
a surface micro-structure layer, disposed on an exterior surface of at least one of the first substrate and the second substrate so as to generate an effect of light deflection.

2. The passive optical device of claim 1, wherein the polymer stabilized liquid crystal material layer comprises a plurality of liquid crystal drops uniformly distributed.

3. The passive optical device of claim 2, wherein a direction in which the liquid crystal molecules are aligned allows a first polarizing state light to reflect and a second polarizing state light to transmit.

4. The passive optical device of claim 1, wherein each of the first substrate and the second substrate comprises an electrode structure allowing application of an electric field so as to change the aligning direction of the liquid crystal molecules.

5. The passive optical device of claim 1, wherein a plurality of slits extending in a direction and parallel to each other is disposed on an interior surface of each of the first substrate and the second substrate respectively.

6. The passive optical device of claim 5, wherein the directions of the plurality of slits on the first substrate and the second substrate parallel to each other.

7. The passive optical device of claim 1, wherein the surface micro-structure comprises a regular linear extending structure, an irregular linear extending structure, a circular micro-lens array or a conical micro-lens array.

8. A light source module, comprising:
a light source unit providing a planar light;
a diffusion plate, disposed above the light source unit for receiving the planar light so as to diffuse it uniformly; and
a passive optical device, disposed behind the diffusion plate, comprising:
a first substrate, disposed at an incident end;
a second substrate, disposed at an emitting end;
a polymer stabilized liquid crystal material layer, disposed between the first substrate and the second substrate and rendered with a polarizing function and a beam-splitting function by an aligning direction of a plurality of liquid crystal molecules; and
a surface micro-structure, disposed on an exterior surface of at least one of the first substrate and the second substrate.

9. The light source module of claim 8, wherein the light source unit comprises:
a light source, emitting an initial light source; and
a light guide component, receiving the initial light source and guiding and converting the initial light source into the planar light.

10. The light source module of claim 8, wherein the polymer stabilized liquid crystal material layer comprises a plurality of liquid crystal droplets uniformly distributed.

11. The light source module of claim 10, wherein a direction in which the liquid crystal molecules are aligned allows a first polarizing state light to reflect and a second polarizing state light to transmit.

12. The light source module of claim 8, wherein a plurality of slits extending in a direction and parallel to each other is disposed on an interior surface of each of the first substrate and the second substrate respectively.

13. The light source module of claim 12, wherein the plurality of slits on the first substrate and the plurality of slits on the second substrate are perpendicular or parallel to each other.

14. The light source module of claim 8, wherein the surface micro-structure comprises a regular linear extending structure, an irregular linear extending structure, a circular micro-lens array or a conical micro-lens array.
